(19) United States
(12) Patent Application Publication
(10) Pub. No.: US 2007/0012051 A1
(43) Pub. Date: Jan. 18, 2007

(54) Method and apparatus of freezing large volumes

(76) Inventors: Elizabeth Acton, Cambridge (GB); George John Morris, Cambridge (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/557,017

(22) PCT Filed: May 17, 2004
(86) PCT No.: PCT/GB04/02116

§ 371 Date: Jan. 26, 2006

(30) Foreign Application Priority Data
May 16, 2003 (GB) 0311236.4

(51) Int. Cl. F25C 1/22; F25C 1/18

(52) U.S. Cl. 62/70; 62/68; 62/340

(57) ABSTRACT

The present invention relates to a method and apparatus for the batch or semi-batch freezing of a large volume of liquid and particularly, but not exclusively, to a method and apparatus for the batch or semi-batch freezing of a large volume of aqueous solution. A method is provided comprising the steps of reducing the temperature of liquid product to a particular temperature below the melting point of said liquid product so as to provide an undercooled liquid product; nucleating ice within the undercooled liquid product at said particular temperature; and further reducing the temperature of said liquid product whilst agitating said liquid product. The liquid product is ideally cooled in a flexible container.

The present invention relates to a method and apparatus for the freezing of a large volume of liquid and particularly, but not exclusively, to a method and apparatus for the batch or semi batch freezing of a large volume of aqueous solution.

The specific issues related to the freezing of large volumes of aqueous samples include:
1) Undercooling—Water and aqueous solutions have a strong tendency to cool below their melting point before nucleation of ice occurs; this undercooling is often referred to as supercooling. For example, although the melting point of ice is 0° C., the temperature of water may be reduced significantly below 0° C. before ice formation occurs: in carefully controlled conditions water may be cooled to approximately −40° C. before ice nucleation becomes inevitable. The phenomenon of undercooling is random and unless controlled it is difficult to devise freezing protocols which are reproducible. In addition, it is known that with many biological samples a large degree of undercooling results in loss of viability on thawing.
2) Inhomogeneity—With large samples it is difficult to achieve a homogenous cooling rate in all the material when using conventional processing methods. This is especially the case in the temperature region following initial ice nucleation; temperature measurements within large samples demonstrate that when using existing freezing equipment, large variations occur across the sample.
3) Cooling rate—Because of the relatively small surface area to volume ratio of conventionally packaged large volume samples it is difficult to process them in a rapid manner or to achieve defined rapid rates of cooling.

In products which are required to be thawed for use (i.e. cryopreserved materials), the rate of thawing is generally very slow in large volume samples and large thermal gradients may exist across the sample.

Depending upon the material to be processed, there are a number of processes for the batch freezing of large volumes of aqueous solutions and these are discussed separately below.

Firstly, certain foodstuffs may be ordinarily consumed frozen or partially frozen, for example ice cream, sorbet and ‘slush’ made from soft drinks and fruit juices, cocktails with or without alcohol, iced tea, iced coffee, milk shakes, frappes etc.

The technology for the commercial manufacture of ice cream and related products is well known and consists of the following steps:
1) Preparation of an appropriate formulation. In those products containing dairy products or other oil-in-water emulsions, it is considered necessary to ‘age or ripen’ the mix at reduced temperatures to allow a proportion of the milk fat in the cream globules to crystallize.
2) The mix is then processed under pressure in a scrape surface heat exchanger and air is introduced into the mix either as it enters the scrape surface cooler or through pins along the rotor. Rapid mixing ensure that small ice crystals formed at the cold wall are distributed into the product. Formation of ice combined with the rapid mixing entraps the air into a semi-frozen product. The product is extruded from the scrape surface heat exchanger at a temperature in the region of −5° C., with some 50% of the water frozen into ice.
3) The extruded ice cream is filled into its final container and further freezing (hardening) is then completed in a conventional blast freezer or tunnel. The product is then transferred to a storage freezer.
4) The frozen ice cream is then distributed through a cold chain to end users, where it may then be stored until required.

The technology for commercial manufacture of ‘slush’-type beverages is broadly similar to the above except that the products are usually made in a batch mode such that the products remains in contact with the scrape surface heat exchanger until it is dispensed from the heat exchanger via a manually operated exit valve into the beverage container.

In addition, the invention also relates to freezing of other liquid foodstuffs including cream, cream fraiche, custards, mayonnaise based products, sauces and dips either for consumption in the frozen state or as a means of preservation.

It is also known to cryopreserve cell suspensions including, for example, embryos and gametes (spermatozoa and oocytes), cell lines, starter cultures for fermentation, bone marrow, erythrocytes, and blood stem cells for use in medicine, agriculture, biotechnology, etc.

For many applications, the volume of the sample to be cryopreserved is typically 1 ml, and for some applications, such as mammalian embryos and oocytes, is 0.25 ml. For the purposes of biological cryopreservation, large volumes would be defined as being from 5 to 1000 ml. It is usual to dispense the cell suspension, including an appropriate cryoprotectant, into a flexible bag constructed of a material which is stable at the temperature of frozen storage (manufactured for example by Baxter, Charter Medical). To ensure uniform bag thickness, the filled bags are placed between hinged metal plates. The bags and their holders are then processed, usually within a controlled rate freezing apparatus (manufactured for example by Planer Products) in which the temperature of the freezing chamber is controlled by the injection of cold liquid nitrogen gas. For some applications, cooling is achieved passively by placing the bag and bag holder into a deep freeze or directly into liquid nitrogen.

Furthermore, the freezing of biologically active molecules, especially protein solutions, has become increasingly important as the biotechnology industry operates multiproduct production facilities on a campaign basis. Companies can then freeze and store product generated in a short production campaign until required. The frozen product can be thawed and moved through the fill and finish steps of manufacturing according to market demands. Small volumes 10 to 1000 ml may be processed as described for bulk cell suspensions above. However, the requirement is to process larger volumes up to 500 litres. Specialised equipment is produced for batch freezing of large samples by for example Integrated Biosystems. This consists of jacketed tanks into which the product is filled and then cooled by circulation of an external coolant, the rate of heat exchange may be increased by fins etc. Once frozen, the product is stored in a cold room in the tank. This system ensures that sterility etc. of the product is maintained.

Depending upon the material to be processed, a number of problems are encountered during the batch freezing of large volumes of aqueous solutions and these are discussed separately below.

The characteristic texture of ice cream results from the formation of discrete ice crystals within a closed cell foam. The continuous phase of this foam is a concentrated sugar syrup containing other dissolved materials together with fat globules. The perceived quality of ice cream is largely determined by the size of the ice crystals. This product structure means that commercial ice cream production is a highly centralised process and a large proportion of the costs lie in frozen distribution and storage.

In addition, as a result of the production and distribution methods, many conventional ice creams require a number of chemical additives to control the initial size and regrowth of ice crystals. Whilst small ice crystals are produced during conventional manufacture of frozen products, these tend to increase in size at a slow rate during storage at temperatures (<−18° C.) conventionally used by the food industry. Any increase in product temperatures which occur during distribution and storage will further accelerate this process. Additives reduce the rate of ice crystal growth, but their presence reduces product quality, imparting a distinctive taste and texture. Products which have no additives generally have a poor shelf life or have a formulation which makes them very expensive.

There are no satisfactory commercial ways of rapidly producing ice cream or similar products upon demand. Small batch scrape surface heat exchangers exist for domestic use, but are inconvenient for commercial application. Such methods of manufacture also lead to dangers of microbial contamination and resulting food poisoning.

There are described technologies for rapid manufacture of ‘soft serve’ ice cream, however this process produces, in a quasi-continuous manner, an unsatisfactory, highly whipped, low quality ice cream from a powdered pre-mix.

In addition there are many types of equipment for the production of slush drinks either in a quasi-continuous or batch manner. The problems which exist with these types of equipment are:
The machine needs to be cleaned regularly—otherwise microbiological problems may occur.
The ice crystal structure of the slush is relatively granular and is generally too large to be taken up by a drinking straw.
Depending upon demand, slush may be retained within the machine for many hours or even days, which may lead to a further coarsening of the ice crystal structure and mechanical wear on the barrel and scraper blades.
Drinks with a “Diet” formulation generally have a very low solute concentration.
During freezing of these products ice formation is not dendritic, which results in the deposition of planar ice on the barrel. This structure is mechanically hard and can cause abrasion of the scraper blades etc.

Specific problems also exist with the freezing of large volumes of cell suspensions and these are related to the scaling up of the freezing process. Indeed, it is relatively simple to define ‘optimum’ methods of freezing (type and concentration of cryoprotective additive, cooling rate etc.) biological materials, and to implement such methods to the cryopreservation of small volumes (typically <1 ml) frozen in straws, vials etc. However, problems are experienced in freezing large volumes because of the difficulty in achieving a homogenous cooling rate in all the material when using conventional freezers. Some biological materials (for example, human erythrocytes, spermatozoa, bacteria and yeasts) have an optimum rate of cooling>10°C. min⁻¹, and it is difficult to achieve this uniformly in a large volume sample. Finally, to minimise cellular injury, biological samples should be thawed as rapidly as possible, again this is difficult to achieve with large volumes.

For the specific case of red blood cells (erythrocytes), the problems associated with the low rate of cooling and the inhomogeneity of the solidification process are overcome during freezing by the use of very high concentrations of cryoprotectant (i.e. 40% glycerol). Whilst this approach reduces freezing injury, considerable problems are encountered on thawing as the high concentrations of cryoprotectant are needed to be removed before transfusion. This is costly, takes considerable time, and requires specialised equipment.

Methods in which the sample is exposed directly to liquid nitrogen (either by direct immersion of the sample or within a chamber of vapour phase controlled rate freezer) should also be avoided. Liquid nitrogen may contain microbial spores etc. which may contaminate the samples being cryopreserved.

The problems encountered when freezing protein solutions include denaturation of the protein, aggregation and cryoprecipitation. When protein solutions are processed by the conventional technology described above, the rates of cooling that are achievable are very low, resulting in dendritic ice formation, with consequent freeze concentration of the proteins. In addition, large inhomogeneity of cooling rate are encountered within the sample.

From a cost viewpoint, the existing technology is expensive. High specification vessels are “locked up” during the storage of the frozen protein, and it is also a costly process to clean and validate vessels between freezing runs.

We have now devised a method and apparatus for the batch freezing of large volumes of liquid (for example, aqueous solutions) whereby the problems associated with conventional technologies are mitigated or overcome. The invention is considered to be effective with large volumes in the range of 10 ml to 1 litre and is probably effective with volumes up to at least 10 litres.

Embodiments of the present invention will now be described with reference to the accompanying drawings, in which:

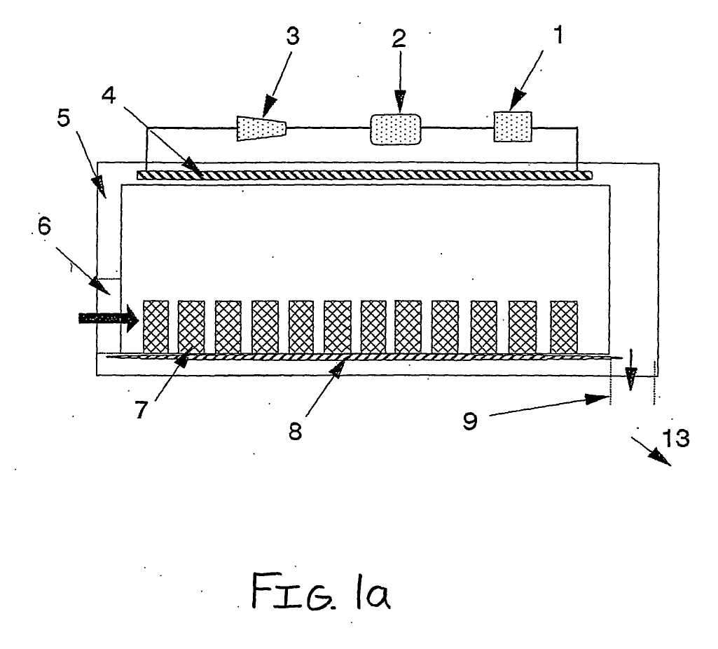

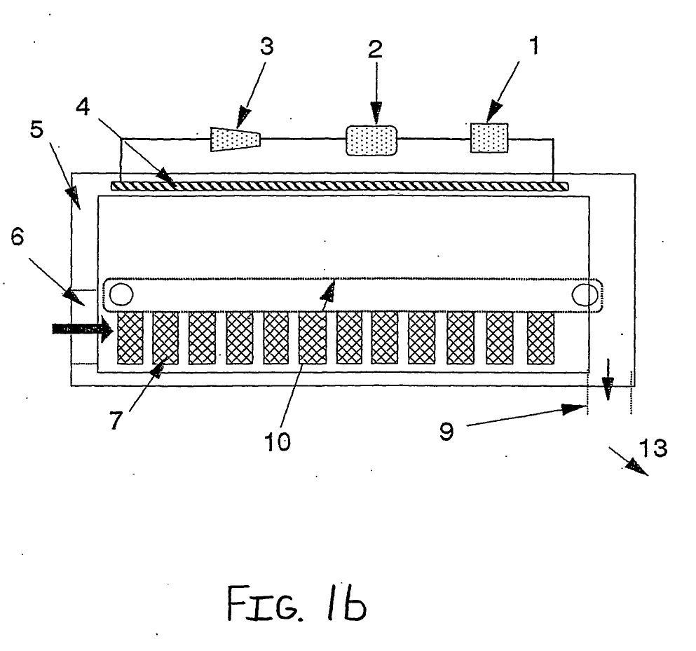

FIG. 1a is a schematic view of an undercooling chamber, with the products being loaded (either directly or from an intermediate loading chamber) on a belt or conveyor;

FIG. 1b is a schematic view of an undercooling chamber, with the products being loaded (either directly or from an intermediate loading chamber) onto a suspension conveyor;

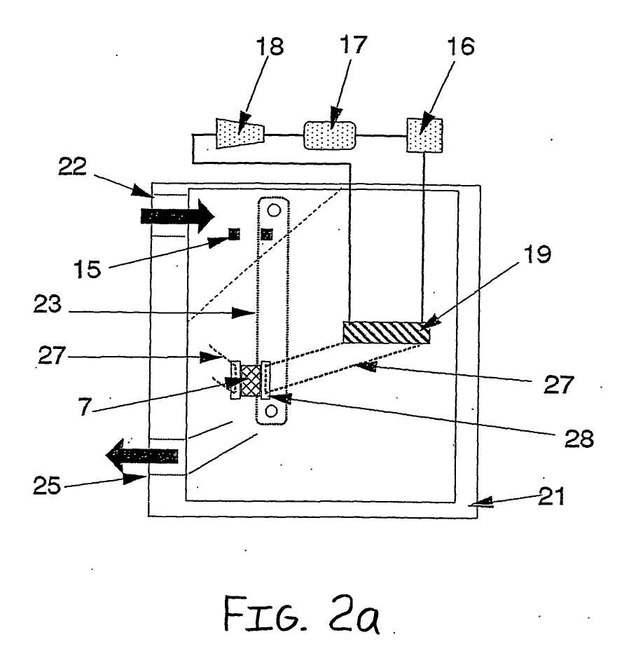

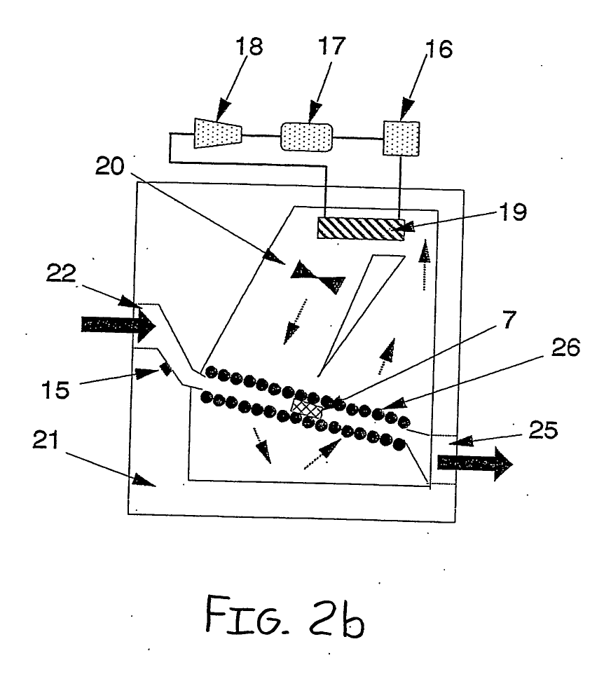

FIG. 2a is a schematic view of a hardening chamber with cooling provided by direct conduction from cooled metal plates which also agitate product during hardening; and

FIG. 2b is a schematic view of a hardening chamber, with cooling provided by circulating air, and product transported and agitated between rollers during hardening.

In an embodiment for the production of ice cream, slush drinks and other such products, a soluble gas such as carbon dioxide or nitrous oxide is introduced into the liquid. The amount of soluble gas is selected such that the degassing which occurs during freezing gives a product with an appropriate over-run at the serving temperature. In a further embodiment, the soluble gas is entrapped within a “widget” (i.e. a separate container) held within the flexible bag or is entrapped within a compartment integral with the flexible bag (i.e. forming part of the bag). The gas is released into the product during manipulation of the product within the flexible bag or when a cap of the bag is removed. In this respect, said manipulation may break the separate container or the compartment, or otherwise encourage a flow therefrom (perhaps through ports in the separate container/compartment).

The product is cooled, with or without agitation, to below its melting point using any appropriate method of refrigeration. In a preferred embodiment, the product is cooled by contact with plates cooled by circulation of a suitable refrigerant (heat sinks). The temperature of the heat sinks may be controlled by the temperature of the circulating coolant or alternatively a thin film heater may be at the surface of the plate and the temperature is then determined by the current to the heater.

As soon as the product is at an appropriate temperature, it is nucleated without any extended period of storage in the undercooled state.

In an alternative embodiment, the product is held in the undercooled state until further processing is required. In this embodiment, the cooling chamber is cooled by circulating refrigerated gas, a refrigeration liquid bath or any other suitable means of refrigeration and should as far as possible be vibration free to avoid nucleation of the undercooled samples. The composition and method of preparation of the mix, the container, and the temperature of the cooling chamber and its mechanical stability are to be selected such that the sample may be held at up to 5° C. of undercooling for at least 12 hours with a very low likelihood of ice nucleation.

Nucleation of the undercooled liquid is achieved by any suitable method but could include release of gas pressure, sonic or ultrasonic treatment, mechanical vibration or stirring etc.

In embodiments of the invention, ultrasonic vibration is generated by electromagnetic, electromechanical, piezoelectric, electrostrictive or magnetostrictive means. The ultrasound is transmitted to the undercooled liquid in its container through heat sink plates.

When the vibration is ultrasonic, sound waves having a frequency of between 16 kHz and 10 MHz, most preferably between 20 kHz and 100 kHz, are employed.

In a preferred embodiment of the invention, the duration of the ultrasonic vibration to induce ice nucleation within the undercooled sample is up to 5 seconds. Ultrasound may be further applied to induce grain refinement.

In a preferred embodiment of the invention, the sample is cooled following ice nucleation by contact with plates cooled by circulation of a suitable refrigerant. The sample is agitated by any convenient method (such as sonic or ultrasonic treatment, mechanical vibration, stirring or massaging) during hardening both to induce grain refinement of the ice crystals and also to minimise thermal gradients. In a further preferred embodiment, the sample is cooled by contact with oscillating metal heat sinks, this motion having the advantage of releasing ice from the walls of the container. The rate of temperature reduction may be chosen to be as rapid as possible in the case of ice cream etc. produced on demand or, in the case of cryopreserved materials, may be chosen to be the optimum cooling rate for the material being processed. The cooling rates may be controlled to be linear or non-linear as desired. The plate motion is reduced or stopped when the ice fraction within the sample reaches a critical level. This may be monitored using appropriate sensors. The position of the plates in their stationary phase can be chosen to produce a product of desired shape. In the case of cryopreserved materials, this would be uniform thickness, whilst for food products other shapes, including conical ones, may be preferred.

In a further embodiment for semi batch processing, a flexible container or bag is used which is ideally tubular with one end connected via a valve to a product reservoir and the other end connected to a dispensing tap. The container/bag is manufactured from a resiliently deformable material which, during the freezing process (preferably, following the initial ice nucleation step), can be manipulated so as to agitate its contents and thereby promote mixing of a contained liquid and reduce/avoid ice accumulation on the container walls (which in turn reduces/avoids an associated reduction in heat transfer). The tubular bag may be cooled by direct contact with a refrigerant in a chamber cooled by the direct expansion of refrigerant gases or by any other suitable means. Agitation and distortion of the tubular bag could be achieved by means of moving plates, a helix which rotates around the bag, or rollers or cylinders which move along the bag. Alternatively, the flexible container could be a bellows which could be expanded and contracted to release ice from the wall and to induce mixing in the bulk fluid. A flexible container such as that mentioned above can be advantageously used in any of the apparatus and methods described herein.

Following processing, the produce would be delivered from the machine in. Its original container ready for consumption. Alternatively, the product may be stored for short periods (hours) within a holding section of the equipment. In an embodiment, the processed product is dispensed from its container at the machine exit.

For those products where the present invention is employed in a processing step before frozen storage, the product requires additional cooling to the storage temperature, typically −20° C. for frozen foodstuffs and −196° C. for cryopreserved cell suspensions. This further cooling may be achieved in the existing chamber or after transfer to a secondary cooling vessel or the final storage chamber.

In a further embodiment of the invention, apparatus may be used to control or accelerate thawing of the product. In this instance, the frozen bag is placed between the heat sinks which are now heated with a circulating fluid. Agitation of the plates may be employed so as to further accelerate thawing.

There are many advantages in the above new method and apparatus over conventional technology. The advantages for foodstuffs include:
1. Economical—all costs associated with shipping of frozen products and frozen storage are removed.
2. High quality—no need to incorporate chemical additives to control ice formation or recrystallisation.
3. No microbial problems associated with cross contamination. Following product sterilisation the container is unopened until delivered from the apparatus.
4. The apparatus may be used to ensure high quality products in regions with poor continuity of electrical supply.
5. The apparatus would be suitable as a vending machine.
6. Novel products would be possible e.g. alcohol-based sorbets where separation of the alcohol can cause difficulties in conventional processing.
7. Products not processed could be removed from the apparatus until a future occasion without compromising product or microbial quality.

The advantages for the cryopreservation of protein solutions and cell suspensions include:
1. Uniformity of cooling rate across the sample.
2. Rapid rates of cooling are possible.
3. No direct contact with liquid nitrogen during the freezing step, reducing any potential contamination arising from liquid nitrogen.
4. The apparatus may be used for rapid thawing of bulk products.

Various further embodiments of the invention are now described with reference to the following examples. EXAMPLE 1

### Demonstration of the Method: Gassed Ice Cream Mix

An ice cream mix was prepared from double cream, sugar and water to contain 60% water, 20% fat and 20% sugar, the melting point of this formulation was approximately—2.5° C. The sample was then gassed with CO₂ from a SodaStream Gemini. Bags of Lucozade isotonic sport drink were drained of their contents and replaced with 100 ml of the mix. The filled bags were then placed in a refrigerated ultrasonic bath (300 W, 20 kHz) containing industrial methylated spirits. The bath was cooled to −7.5° C. and the bags were left in it for 18 hours, during which time there was no ice formation in any of the samples (n=12) examined. The sample was then nucleated by the application of ultrasound. The bags were then transferred to a refrigerated bath (Fryka KB300) containing industrial methylated spirits maintained at −30° C. The bags were vigorously massaged to ensure good mixing of the contents and to release ice from the walls. After 5 minutes of processing, samples were removed from the hardening bath, the screw cap was removed and the product was tasted. The ice crystal structure was perceived to be very small and the sample contained small entrapped gas bubbles. The product over-run was estimated to be 30%. This material had many of the characteristics of conventional ice cream. In contrast, a sample which had not been processed by the method but had been placed directly into the refrigerated bath at −25° C. contained very coarse ice crystals and bore little similarity to ice cream.

### EXAMPLE 2

### Demonstration of the Method: Slush Drinks

Bags of Lucozade isotonic sport drink were drained of their contents and replaced with 200 ml of the drink to be processed (listed below). Carbonated products were used directly whilst non-carbonated drinks were initially degassed and then gassed with a SodaStream Gemini connected to a cylinder of nitrous oxide. The bags were then placed within a portable freezer (Engel 13, Aqua Marine Ltd, Southampton) which was set to operate at a temperature 5° C. below the melting point of the liquid to be processed. Ice did not nucleate in these undercooled samples for at least 72 hours. Bags to be processed were removed from the Engel freezer within this period and insonified in an ultrasonic bath for 5 seconds and then transferred to a refrigerated bath (Fryka KB300) containing industrial methylated spirits maintained at −30° C. The bags were vigorously massaged to ensure good mixing of the contents and to release ice from the walls. Following processing in the bath for 45 to 90 seconds, the bags were removed from the bath and the contents removed either by extrusion or by cutting the bag open. With all products examined, a fine ice structure was achieved which could be consumed via a drinking straw.

Drinks examined: Lilt, Pepsi cola, Sunkist orange, Tango orange, Fruitopia—mind over mango, Fruitopia—strawberry citrus harmony, Calypso orange, Oasis citrus punch, Snapple pink lemonade, Twinings ice tea—raspberry, Twinings ice tea—peach, Nestea, Lipton ice tea, Woody's pink grapefruit, Vault alcoholic soda, Hoopers hooch—lemon, Beefeater gin and tonic, Barcardi breezer—Caribbean key lime, Yazoo chocolate drink, Kahlua and milk, Chocoshake, Nesquick milk drink.

### EXAMPLE 3

### Demonstration of Equipment Configured For Batch Freezing of Beverages, Foodstuffs etc.

As shown in FIG. 1a, a standard refrigeration unit, comprising a compressor 1, a condenser 2, an expansion valve 3 and an evaporator 4, maintains an insulated chamber 5 at typically approximately 5° C. below the melting point of the product. Entry into the chamber 6 allows the product 7 to be cooled and stored in an undercooled state. When the product is required to be frozen, one container is moved via a belt 8 to a position 9 where the container is transported into a hardening chamber 13.

FIG. 1b illustrates an alternative refrigeration unit to FIG. 1a, where the product is transported through the undercooling chamber by being suspended from a conveyor 10. A hardening chamber is shown as FIG. 2a. As in the undercooling chamber, cooling is provided from a standard refrigeration unit comprising a compressor 16, a condenser 17, an expansion valve 18 and an evaporator 19. Secondary coolant 27 is pumped through a heat exchanger incorporating the evaporator 19 and through a set of drilled metal cooling plates 28 (a single pair or multiple pairs). The product enters this chamber through an automatic door 22 onto a conveyor 23, which positions the product firstly at the nucleating transducer(s) 15, and then positions the product 7 between the cooling plates 28. The cooling plates perform a rocking motion to induce agitation of the product within its container. The plates present a convex surface to the product to aid this process. Once the product is hardened, the exit door 25 opens and the product is dispensed.

FIG. 2b demonstrates another embodiment for the hardening chamber. Cooling is provided by a standard refrigeration unit 16-19. Air is drawn over the evaporator 19 with a fan 20 and circulated through a set of metal rollers 26. This air circulation cools the rollers which in turn cool the product 7 by conductive heat-transfer. The products enters this chamber through an automatic door 22 and is nucleated by the nucleating device(s) 15. The product is then grasped by the rollers, some of which are driven, and moved along the rollers before being dispensed through the exit door 25. This motion of the rollers also provides any required agitation.

### EXAMPLE 4

### Demonstration of Equipment Configured for Cellular Cryopreservation

Bags containing a cell suspension to be frozen are sandwiched horizontally between an upper and lower set of plates. Each plate contains a surface plate in contact with the bag (which is machined to fit closely with the contours of the filled bag), a thin film heater and a heat sink cooled by an appropriate cryogenic refrigerant. The temperature of the surface plate is controlled by a Eurothern controller operating the heater in each plate. Appropriate refrigerants include cryogenic gases such as liquid nitrogen or liquid helium, or silicon oil cooled via an external heat exchanger. On the outer surfaces of the plates, ultrasonic transducers are bonded. The bottom plate is fixed and the top plate is connected to a mechanism which allows it to rock along its longitudinal axis.

In one demonstration, cell suspensions were frozen in cryocyte bags (product no R4R9955, Nexell International SPRL). The bags were filled with 100 ml of a washed red cell suspension containing the cryoprotectant glycerol (15% v/v). The red cells were cooled with agitation to −7.5° C. at a rate of cooling of 10° C. min⁻¹ and nucleated by applying ultrasound to the bags for 5 seconds. The sample was then maintained at −7.5° C. for 5 minutes to allow the equilibrium amount of ice to form at that temperature and then cooled rapidly by a non-linear profile, at an average rate of cooling of 10° C. min⁻¹ to −60° C. and then transferred to liquid nitrogen. The recovery on thawing was 93%. An identical sample of red bloods cells (100 ml volume, 15% v/v glycerol) processed in a controlled rate freezer, programmed to cool at a linear rate of 10° C. min⁻¹ had a recovery of 50% upon thawing.

1. A method of freezing a volume of liquid product, the method comprising the steps of reducing the temperature of liquid product to a particular temperature below the melting point of said liquid product so as to provide an undercooled liquid product; nucleating ice within the undercooled liquid product at said particular temperature; and further reducing the temperature of said liquid product whilst agitating said liquid product; wherein said steps are undertaken with the liquid product held in a resiliently deformable container.

2. A method of freezing as claimed in claim 2, wherein the step of nucleating ice within the undercooled product at said particular temperature comprises agitating said liquid product.

3. A method of freezing as claimed in claim 1, wherein said liquid product is stored at said particular temperature prior to the step of further reducing the temperature of said liquid product.

4. A method of freezing as claimed in claim 1, the method comprising the further step of increasing the likelihood of cavitation in said liquid product in response to said agitation.

5. A method of freezing as claimed in claim 4, wherein the step of increasing the likelihood of cavitation comprises reducing the ambient pressure associated with said liquid product and agitating said liquid product at the reduced pressure.

6. A method of freezing as claimed in claim 4, wherein the step of increasing the likelihood of cavitation comprises dissolving a volatile fluid in said liquid product prior to said agitation.

7. A method of freezing as claimed in claim 6, wherein the volatile fluid is carbon dioxide, nitrous oxide or an alcohol.

8. A method of freezing as claimed in claim 1, wherein said particular temperature is up to 10° C. below the melting point of said liquid product.

9. A method of freezing as claimed in claim 8, wherein said particular temperature is 7.5° C. below the melting point of said liquid product.

10. A method of freezing as claimed in claim 1, wherein said liquid product is agitated for a sustained period of five seconds.

11. A method of freezing as claimed in claim 10, wherein the step of agitating said liquid product comprises vibrating said liquid product.

12. A method of freezing as claimed in claim 1, wherein said liquid product is vibrated at a sonic or ultrasonic frequency.

13. A method of freezing as claimed in claim 12, wherein said liquid product is vibrated at a frequency of between 16 kHz and 10 MHz.

14. A method of freezing as claimed in claim 13, wherein said liquid product is vibrated at a frequency of between 20 kHz and 100 kHz.

15. A method of freezing as claimed in claim 1, wherein agitation of said liquid product is stopped or reduced when the ice fraction within said liquid product reaches a predetermined level.

16. A method of freezing as claimed in claim 1, wherein said liquid product is agitated by oscillating cooling means in contact with said liquid product.

17. A method of freezing as claimed in claim 1, wherein said resiliently deformable container has an elongate shape.

18. A method of freezing as claimed in claim 17, wherein a first end of said container is in fluid communication with a source of liquid product; and a second end of said container, distill to said first end, is in fluid communication with a port for dispensing frozen liquid product.

19. A method of freezing as claimed in claim 17, wherein said liquid product is agitated by deforming said container.

20. A method of freezing as claimed in claim 19, wherein said container is deformed by rollers moving along an exterior surface of said container.

21. A method of freezing as claimed in claim 19, wherein said container is deformed by a helical member rotating about an exterior surface of said container.

22. A method of freezing as claimed in claim 1, wherein said container is moved to and retained in a particular shape so that said liquid product freezes in a predetermined shape.

23. A method of freezing as claimed in claim 1, wherein a fluid is releasably entrapped in an enclosure so as to be separated from said liquid product and is located such that said fluid is released from said enclosure in response to agitation of said liquid product.

24. A method of freezing as claimed in claim 23, wherein said fluid is a soluble gas.

25. (canceled)

26. A frozen or partially frozen liquid product prepared in accordance with a method as claimed in claim 1.

27. (canceled)

28. Apparatus for freezing a volume of liquid product, the apparatus comprising a resiliently deformable container for receiving liquid product; means for reducing and maintaining the temperature of the liquid product below its melting point; and means for deforming said container.

29. Apparatus as claimed in claim 28 further comprising an undercooling chamber comprising said means for reducing and maintaining the temperature of the liquid product below its melting point; means for nucleating the undercooled product; and a hardening chamber comprising said deforming means and a means of cooling the nucleated product to a final serving temperature.

30. Apparatus as claimed in claim 29 further comprising means for conveying liquid product between the undercooling chamber and the hardening chamber.

31. Apparatus as claimed in claim 28, wherein said deforming means comprises means for vibrating said container so as to agitate liquid product contained therein.

32. Apparatus as claimed in claim 31, wherein said vibrating means is adapted to vibrate said material receiving means at a frequency of between 16 kHz and 10 MHz, and preferably at a frequency of between 20 kHz and 100 kHz.

33. Apparatus as claimed in claim 31, where said vibrating means comprises at least one transducer.

34. Apparatus as claimed in claim 28, further comprising separating means for selectively separating said liquid product from a further fluid in said container.

35. Apparatus as claimed in claim 34, wherein said separating means is adapted to release said further fluid from an enclosure containing said fluid in response to a deforming of said container.

36. (canceled)
